(19) United States
(12) Patent Application Publication
(10) Pub. No.: US 2024/0081311 A1
(43) Pub. Date: Mar. 14, 2024

(54) FISHING ASSEMBLY

(71) Applicants: Peter Mitchel Klym, Gimli (CA); Paulette Klym, Gimli (CA)

(72) Inventors: Peter Mitchel Klym, Gimli (CA); Paulette Klym, Gimli (CA)

(21) Appl. No.: 17/930,947

(22) Filed: Sep. 9, 2022

(51) Int. Cl. A01K 91/047; A01K 95/02

(52) U.S. Cl. CPC A01K 91/047; A01K 95/02

(57) ABSTRACT

A fishing assembly that is configured to provide suspension of two baits wherein the present invention is utilized in bottom fishing. The present invention includes a first hook rig and a second hook rig operably coupled to a main line. A connector is present at one end of the main line and is configured to be secured to a fishing line. Opposite the connector on the main line is a coupling for a weight. The first hook rig and second hook rig include T-shaped hook support members. First bead members are adjacent the first portion of the hook support members. Float members are mounted on the main line adjacent the first bead members. Adjacent to the float members opposite the first bead members are the second bead members. The float members, first bead members and second bead members can be provided in alternate sizes, shapes and colors.

### FIELD OF THE INVENTION

The present invention relates generally to fishing equipment, more specifically but not by way of limitation, a fishing assembly that includes a main line having a first hook rig and a second hook rig wherein the present invention provides maintenance of the first hook rig and second hook rig off the bottom.

### BACKGROUND

Millions of individuals routinely engage in the sport of fishing. Fishing includes two general categories being comprised of commercial fishing and recreational fishing. While some commercial fishing involves the utilization of conventional hook and line techniques, most of the commercial fishing will involve high capacity techniques such as but not limited to nets. Recreational fishing typically involves hook and line techniques wherein the recreational angler will utilize a rod and reel with the line secured to the reel being tied to various different rigs and baits.

Utilization of a rod and reel typically comprises two broad categories of either trolling or bottom fishing. During trolling, the rod and line are tied to various lures and other rigs and dragged behind a moving boat wherein the lures are primarily kept at the surface. For bottom fishing, the fishing line is secured to a rig that includes a weight wherein the weight will carry and hold a desired bait at or proximate the bottom. Conventional rigs will utilize a fishing weight that includes a loop wherein the loop can either be tied directly to the line or clipped to the line if the fishing line has a clip tied thereto. The fishing weight is typically secured to the line wherein the line further includes a rig set up for the type of bottom fishing that will be performed. The type of rig can vary and can include one or more than one hooks. One issue with multiple rigs or even single rigs is maintaining the hook above the bottom. Most conventional rigs place the bait and hook on the bottom. This can work for some applications but is undesirable for applications in which it is desired to maintain the hooked bait off of the bottom. This can be especially true when fishing multiple rigs.

Accordingly, there is a need for a fishing assembly that is configured with more than one hook rig wherein the present invention is configured to maintain both hooked rigs from contacting the bottom during fishing.

### SUMMARY OF THE INVENTION

It is the object of the present invention to provide a fishing assembly that is configured with a first hook rig and a second hook rig wherein the present invention includes a main line operably coupling the first hook rig and the second hook rig.

Another object of the present invention is to provide a fishing assembly operable to provide suspension of a hooked bait off of the bottom during bottom fishing that further includes a hook support member with the hook support member being T-shaped.

A further object of the present invention is to provide a fishing assembly that is configured with a first hook rig and a second hook rig wherein the hook support member includes a loop on the vertical support member thereof.

Still another object of the present invention is to provide a fishing assembly operable to provide suspension of a hooked bait off of the bottom during bottom fishing wherein the first hook rig and second hook rig include float members adjacent the first horizontal support member and second horizontal support member of the hook support member.

An additional object of the present invention is to provide a fishing assembly that is configured with a first hook rig and a second hook rig wherein the first hook rig includes bead members on opposing sides of each float member.

Yet a further object of the present invention is to provide a fishing assembly operable to provide suspension of a hooked bait off of the bottom during bottom fishing wherein the second hook rig includes bead members on opposing sides of each float member.

Another object of the present invention is to provide a fishing assembly that is configured with a first hook rig and a second hook rig that includes connectors on opposing end of the main line.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an embodiment of the present invention; and

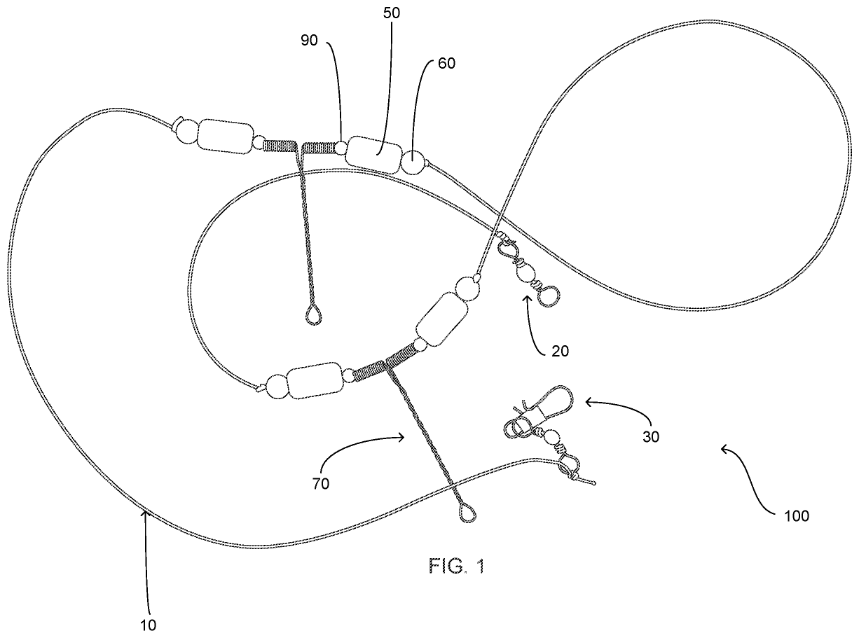

FIG. 2 is a perspective view of an embodiment of the present invention with the float members attached and with the float members removed.

### DETAILED DESCRIPTION

Referring now to the drawings submitted herewith, wherein various elements depicted therein are not necessarily drawn to scale and wherein through the views and figures like elements are referenced with identical reference numerals, there is illustrated a fishing assembly 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted as a part hereof, the fishing assembly 100 includes a main line 10. The main line 10 includes a first portion 11, second portion 12 and third portion 13. The main line 10 is manufactured from a suitable material such as but not limited to monofilament. It should be understood within the scope of the present invention that the main line 10 could be provided in various lengths as well as the material could be provided in alternate strength ratings. Secured to the first end 15 of the first portion 11 is connector 20. Connector 20 provides a union interface to secure an end of fishing line (not illustrated herein) that is operably coupled to a conventional rod and reel. It should be understood within the scope of the present invention that the connector 20 could be various alternate types of suitable mechanical fasteners. By way of example but not limitation, the connector 20 can be provided as a swivel connector.

Secured to the second end 19 of the third portion 13 is a weight connector 30. Weight connector 30 is secured to second end 19 utilizing suitable techniques such as but not limited to a tied knot. The weight connector 30 is provided as an interface to operably couple to a conventional fishing weight. During use of the fishing assembly 100 the user will dispense a sufficient amount of line from the rod and reel such that the fishing weight secured to the weight connector 30 is placed on the bottom. It is contemplated within the scope of the present invention that numerous fasteners could be utilized as the weight connector 30. Furthermore, it should be understood within the scope of the present invention that the fishing assembly 100 could be provided without a weight connector 30 wherein a fishing weight would be directly tied to the second end 19 of the third portion 13.

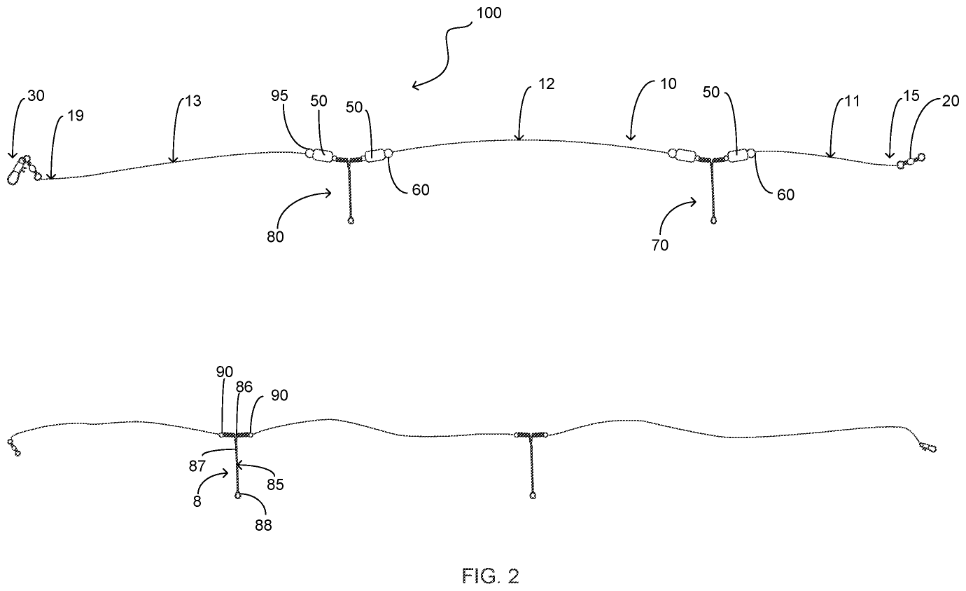

Referring in particular to FIG. 2 submitted herewith, the fishing assembly 100 is illustrated twice wherein the float members 50 and second bead members 60 have not been installed on the fishing assembly 100 so as to provide clear illustration of the fishing assembly 100. The fishing assembly 100 includes a first hook rig 70 and a second hook rig 80. The first hook rig 70 and second hook rig 80 are identically manufactured so it should be understood the ensuing discussion on the second hook rig 80 applies to the first hook rig 70. The second hook rig 80 includes hook support member 85. Hook support member 85 includes first portion 86 and second portion 87 wherein the second portion 87 is perpendicular to the first portion 86. A loop member 88 is formed on the second portion 87 distal to the first portion 86. The loop member 88 provides an interface to secure a hook and bait.

Adjacent to each end of the first portion 86 of the second hook rig 80 are the first bead members 90. The first bead members 90 are slidably mounted onto the second portion 12 and third portion 13. The bead members 90 are manufactured from a material such as but not limited to plastic. It should be understood within the scope of the present invention that the first bead members 90 could be provided in numerous alternate colors, sizes and further have phosphorescence properties. The second hook rig 80 further includes float members 50. The float members 50 are adjacent each first bead member 90. The float members 50 are manufactured from a buoyant material and are configured to provide the desired suspension and action of the second hook rig 80. It should be understood within the scope of the present invention that the float member 50 could be provided in alternate sizes and shapes. Furthermore, it is contemplated within the scope of the present invention that the float member 50 could be provided with a light source or have phosphorescent properties.

Secured to the main line 10 adjacent to the float member 50 on an opposing side from the first bead member 90 are the second bead members 60. The second bead members 60 are manufactured from plastic or other suitable material and are secured utilizing suitable techniques. The second bead members 60 function to preserve the integrity of the float members 50 as well as provide color and/or light refraction to attract fish. It should be understood within the scope of the present invention that the second bead members 60 could be provided in alternate sizes, colors and further be phosphorescent. While a first hook rig 70 and second hook rig 80 are illustrated herein, it should be understood within the scope of the present invention that the fishing assembly 100 could be provided with less than or more than two hook rigs.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A fishing assembly that is operable to be utilized for bottom fishing wherein the fishing assembly comprises:
a main line, said main having at least two portions, said main line having a first end and a second end;
at least one hook rig, said at least one hook rig being operably coupled to said main line, said at least one hook rig having a hook support member, said hook support member being T-shaped, said hook support member having a loop member formed at an end of a second section thereof distal to a first section;
a pair of first bead members, said pair of first bead members being mounted adjacent said first section of said hook support member at opposite ends thereof;
a first float member and a second float member, said first float member and said second float member being manufactured from a buoyant material, said first float member and said second float member being secured to said main line, said first float member and said second float member being located adjacent said pair of first bead members on opposing ends of said first section of said hook support member; and
a pair of second bead members, said pair of second bead members being secured to said main line, said pair of second bead members being secured adjacent said first float member and said second float member opposite said pair of first bead members.

2. The fishing assembly that is operable to be utilized for bottom fishing as recited in claim 1, wherein said pair of second bead members are larger than that of said pair of first bead members.

3. The fishing assembly that is operable to be utilized for bottom fishing as recited in claim 2, wherein said first float member and said second float member are cylindrical in shape.

4. The fishing assembly that is operable to be utilized for bottom fishing as recited in claim 3, and further including a connector, said connector being secured to said first end of said main line, said connector operable to couple the fishing assembly to a fishing line.

5. The fishing assembly that is operable to be utilized for bottom fishing as recited in claim 4, and further including a weight connector, said weight connector being secured to said second end of said main line, said weight connector configured to be operably coupled to a fishing weight.

6. A fishing assembly that is operable to be utilized for bottom fishing wherein the fishing assembly comprises:
a main line, said main line having a first portion, a second portion and a third portion, said main line having a first end and a second end;
a first hook rig, said first hook rig having a hook support member, said hook support member having a first section and a second section, said second section being perpendicular to said first section and extending outward therefrom, said second section having a loop member formed at an end thereof distal to said first section, said first hook rig being secured intermediate said first portion and said second portion of said main line, said first hook rig having a pair of first bead members, said pair of first bead members being secured to adjacent to said first section of said hook support member at opposing ends thereof, a first float member and a second float member, said first float member and said second float member being secured to said main line adjacent the pair of first bead members, said first float member and said second float member being manufactured from a buoyant material, said first hook rig further having a pair of second bead members, said pair of second bead member being secured to said main line adjacent said first float member and said second float member opposite said pair of first bead members;
a second hook rig, said second hook rig having a hook support member, said hook support member of said second hook rig having a first section and a second section, said second section of said hook support member of said second hook rig being perpendicular to said first section of said hook support member of said second hook rig and extending outward therefrom, said second section of said hook support member of said second hook rig having a loop member formed at an end thereof distal to said first section of said hook support member of said second hook rig, said second hook rig being secured intermediate said second portion and said third portion of said main line, said second hook rig having a pair of first bead members, said pair of first bead members being secured to adjacent to said first section of said hook support member of said second hook rig at opposing ends thereof, a first float member and a second float member, said first float member and said second float member being secured to said main line adjacent the pair of first bead members of said second hook rig, said first float member and said second float member being manufactured from a buoyant material, said second hook rig further having a pair of second bead members, said pair of second bead members of said second hook rig being secured to said main line adjacent said first float member and said second float member of said second hook rig opposite said pair of first bead members of said second hook rig.

7. The fishing assembly that is operable to be utilized for bottom fishing as recited in claim 6, wherein said first pair of bead members and said second pair of bead members of said first hook rig are different sized.

8. The fishing assembly that is operable to be utilized for bottom fishing as recited in claim 7, wherein said first pair of bead members and said second pair of bead members of said second hook rig are different sized.

9. The fishing assembly that is operable to be utilized for bottom fishing as recited in claim 8, wherein said second pair of bead member of said first hook rig are larger than that of said first pair of bead members of said first hook rig.

10. The fishing assembly that is operable to be utilized for bottom fishing as recited in claim 9, wherein said second pair of bead member of said second hook rig are larger than that of said first pair of bead members of said second hook rig.

11. The fishing assembly that is operable to be utilized for bottom fishing as recited in claim 10, wherein said first float member and said second float member of said first hook rig are cylindrical in shape.

12. The fishing assembly that is operable to be utilized for bottom fishing as recited in claim 11, wherein said first float member and said second float member of said second hook rig are cylindrical in shape.
